(19) United States
(12) Patent Application Publication
(10) Pub. No.: US 2015/0301932 A1
(43) Pub. Date: Oct. 22, 2015

(54) NONVOLATILE MEMORY SYSTEM AND METHOD OF PERFORMING OPERATION OF THE NONVOLATILE MEMORY SYSTEM

(71) Applicants: Moon-wook OH, Seoul (KR); Jae-hoon HEO, Suwon-si (KR)

(72) Inventors: Moon-wook OH, Seoul (KR); Jae-hoon HEO, Suwon-si (KR)

(21) Appl. No.: 14/665,337

(22) Filed: Mar. 23, 2015

(30) Foreign Application Priority Data
Apr. 21, 2014 (KR) 10-2014-0047601

(51) Int. Cl. G06F 12/02; G05D 23/19

(52) U.S. Cl. CPC G06F 12/0238; G05D 23/1917; G06F 2212/202

(57) ABSTRACT

According to example embodiments, a nonvolatile memory system includes a nonvolatile memory device includes a nonvolatile memory cell array, a temperature sensor configured to measure a temperature of the nonvolatile memory device, and a memory controller configured to adjust an execution frequency of a memory management operation based on a desired (and/or alternatively predetermined) temperature range and the measured temperature.

### CROSS-REFERENCE TO RELATED APPLICATIONS

This application claims priority under 35 U.S.C. §119 to Korean Patent Application No. 10-2014-0047601, filed on Apr. 21, 2014, in the Korean Intellectual Property Office, the disclosure of which is incorporated herein in its entirety by reference.

### BACKGROUND

The present disclosure relates to a nonvolatile memory system and/or a method of operating the nonvolatile memory system, and more particularly, to a nonvolatile memory system that performs a memory management operation according to temperature and/or a method of operating the nonvolatile memory system.

A data storage device that may retain stored data even when not powered is referred to as a nonvolatile memory. Examples of nonvolatile memory include a read-only memory (ROM), a magnetic disc, an optical disc, and a flash memory. The flash memory refers to a memory that stores data as a threshold voltage of a metal-oxide semiconductor (MOS) transistor changes. Example of flash memory include a NAND flash memory and a NOR flash memory. Operating characteristics of flash memory may vary according to temperature. It is desirable to ensure high operational reliability of a flash nonvolatile memory device.

### SUMMARY

The present application relates to a nonvolatile memory system that may ensure high operational reliability and a method of operating the nonvolatile memory system.

According to example embodiments, a nonvolatile memory system includes: a nonvolatile memory device including a nonvolatile memory cell array; a temperature sensor configured to measure a temperature of the nonvolatile memory device; and a memory controller configured to adjust an execution frequency of a memory management operation performed on the nonvolatile memory device based on a desired (and/or alternatively predetermined) temperature range and the measured temperature.

In example embodiments, the memory controller may be configured to store information about when the desired (and/or alternatively predetermined) temperature range suitable for performing the memory management operation, and the memory controller may be configured to perform the memory management operation when the measured temperature of the nonvolatile memory device is in the desired (and/or alternatively predetermined) temperature range.

In example embodiments, the memory controller may be configured to adjust the temperature of the nonvolatile memory device if the measured temperature of the nonvolatile memory device is outside the desired (and/or alternatively predetermined) temperature range.

In example embodiments, if the measured temperature of the nonvolatile memory device is outside the desired (and/or alternatively predetermined) temperature range, the memory controller may be configured to determine whether to perform the memory management operation based on a capacity of an empty space of the nonvolatile memory device where data is to be stored.

In example embodiments, the memory controller may be configured to increase the execution frequency of the memory management operation if the measured temperature is in the desired (and/or alternatively predetermined) temperature range.

In example embodiments, the memory controller may be configured to store information about the memory management operation corresponding to each temperature range, and the memory controller may be configured to perform the memory management operation corresponding to a temperature range including the measured temperature.

In example embodiments, the desired (and/or alternatively predetermined) temperature range may be set based on an operating temperature range of the nonvolatile memory device or operating characteristics of the nonvolatile memory device.

In example embodiments, the desired (and/or alternatively predetermined) temperature range may be set based on a temperature corresponding to a write operation of the nonvolatile memory device.

In example embodiments, the memory controller may be configured to store a temperature corresponding to a write operation or a read operation of the nonvolatile memory device, and may be configured to set the desired (and/or alternatively predetermined) temperature range based on the stored temperature.

In example embodiments, the memory management operation may include at least one of an erase operation for erasing data written to memory cells of the memory cell array, a wear leveling operation for adjusting a number of write operations between the memory cells, a read-refresh operation for adjusting a number of read operations between the memory cells, a garbage collection operation for generating free blocks, and an error check and correction (ECC) operation for correcting an error of written data.

In example embodiments, the memory cell array may include memory cells on a substrate. A plurality of the memory cells may be in a same string and stacked on top of each other in a direction that is perpendicular to a substrate.

According to example embodiments, a nonvolatile memory system includes: a nonvolatile memory device including a memory cell array; a temperature sensor configured to measure a temperature of the nonvolatile memory device; and a memory controller configured to perform a memory management operation corresponding to the measured temperature of the nonvolatile memory device.

In example embodiments, the memory controller may include a temperature information storage unit configured to store information about the memory management operation corresponding to each temperature range of the nonvolatile memory device.

In example embodiments, the nonvolatile memory system may be configured to store temperature information corresponding to an operation of the nonvolatile memory device in a memory cell of the nonvolatile memory device or the memory controller.

In example embodiments, the memory controller may be configured to perform the memory management operation in an idle state or a sleep state.

According to example embodiments, a nonvolatile memory system includes: a nonvolatile memory device including a memory cell array; a temperature sensor configured to measure a temperature of the nonvolatile memory device; and a memory controller configured to control at least one of an execution and a delay of a memory management operation performed on the nonvolatile memory device according to a relationship based on the measured temperature, a first temperature threshold, and a second temperature threshold. The first temperature threshold is different than the second temperature threshold.

In example embodiments, the memory controller may be configured to delay the memory management operation if the measured temperature is outside a desired temperature range based on the first temperature threshold and the second temperature threshold. The memory controller may be configured to perform the memory management operation on the nonvolatile memory device when the measured temperature is inside the desired temperature range. The memory controller may be configured to adjust the temperature of the nonvolatile memory device if the measured temperature of the nonvolatile memory device is outside the desired temperature range. The memory controller may be configured to re-measure the temperature of the nonvolatile memory device after the temperature of the nonvolatile memory device has been adjusted. The memory controller may be configured to perform the memory management operation on the nonvolatile memory device if the re-measured temperature is inside the desired temperature range.

In example embodiments, if the measured temperature of the nonvolatile memory device is outside a desired temperature range based on the first temperature threshold and the second temperature threshold, the memory controller may be configured to determine whether to perform the memory management operation based on determining an availability of memory resources in the nonvolatile memory device where data is to be stored, the memory controller may be configured to perform the memory management operation on the nonvolatile memory device if the memory controller determines the availability of memory resources is insufficient, and the memory controller may be configured to perform the memory management operation if the measured temperature of the nonvolatile memory device is inside the desired temperature range.

In example embodiments, the memory cell array may include memory cells on a substrate. A plurality of the memory cells in a same string may be stacked on top of each other in a direction perpendicular to the substrate. The memory management operation may include at least one of an erase operation for erasing data written to the memory cells of the memory cell array, a wear leveling operation for adjusting a number of write operations between the memory cells, a read-refresh operation for adjusting a number of read operations between the memory cells, a garbage collection operation for generating free blocks, and an error check and correction (ECC) operation for correcting an error of written data.

### BRIEF DESCRIPTION OF THE DRAWINGS

The foregoing and other features of inventive concepts will be apparent from the more particular description of non-limiting embodiments of inventive concepts, as illustrated in the accompanying drawings in which like reference characters refer to like parts throughout the different views. The drawings are not necessarily to scale, emphasis instead being placed upon illustrating principles of inventive concepts. In the drawings:

FIG. 1 is a block diagram illustrating a nonvolatile memory system according to example embodiments of inventive concepts;

FIGS. 2A and 2B are diagrams illustrating a memory cell array of FIG. 1, according to example embodiments of inventive concepts;

FIGS. 3A through 3C are diagrams illustrating a threshold voltage distribution of a memory cell, according to example embodiments of inventive concepts;

FIG. 4 is a block diagram illustrating the nonvolatile memory system of FIG. 1, according to example embodiments of inventive concepts;

FIG. 5 is a block diagram illustrating a background operation unit (BOU) of FIG. 1, according to example embodiments of inventive concepts;

FIG. 6 is a temperature information table showing a temperature range suitable for a memory management operation, according to example embodiments of inventive concepts;

FIGS. 7A and 7B are diagrams for explaining a method of setting temperature information in order to perform an error check and correction (ECC) operation as a memory management operation, according to example embodiments of inventive concepts;

FIG. 8 is a flowchart illustrating a method of operating the nonvolatile memory device, according to example embodiments of inventive concepts;

FIG. 9 is a flowchart illustrating a method of operating the nonvolatile memory device, according to example embodiments of inventive concepts;

FIG. 10 is a flowchart illustrating a method of operating the nonvolatile memory device, according to example embodiments of inventive concepts;

FIG. 11 is a flowchart illustrating a method of operating the nonvolatile memory device, according to example embodiments of inventive concepts;

FIG. 12 is a block diagram illustrating a nonvolatile memory system according to example embodiments of inventive concepts;

FIG. 13 is a block diagram illustrating a nonvolatile memory system according to example embodiments of inventive concepts;

FIG. 14 is a block diagram illustrating a nonvolatile memory system according to example embodiments of inventive concepts;

FIG. 15 is a block diagram illustrating a computing system to which a nonvolatile memory system is applied, according to example embodiments of inventive concepts;

FIG. 16 is a block diagram illustrating a solid-state drive (SSD) according to example embodiments of inventive concepts;

FIG. 17 is a diagram illustrating a network system and a server system including the SSD of FIG. 16, according to example embodiments of inventive concepts;

FIG. 18 is a diagram illustrating a memory card according to example embodiments of inventive concepts; and

FIG. 19 is a flowchart illustrating a method of operating the nonvolatile memory device, according to example embodiments of inventive concepts.

### DETAILED DESCRIPTION OF THE EMBODIMENTS

Example embodiments will now be described more fully with reference to the accompanying drawings, in which some example embodiments are shown. Example embodiments, may, however, be embodied in many different forms and should not be construed as being limited to the embodiments set forth herein; rather, these example embodiments are provided so that this disclosure will be thorough and complete, and will fully convey the scope of example embodiments of inventive concepts to those of ordinary skill in the art. In the drawings, the thicknesses of layers and regions are exaggerated for clarity. Like reference characters and/or numerals in the drawings denote like elements, and thus their description may be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”). As used herein, the term “and/or” includes any and all combinations of one or more of the associated listed items. Expressions such as “at least one of,” when preceding a list of elements, modify the entire list of elements and do not modify the individual elements of the list.

It will be understood that, although the terms “first”, “second”, etc. may be used herein to describe various elements, components, regions, layers and/or sections. These elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terms used in the present specification are merely used to describe particular embodiments only, and are not intended to limit the scope of example embodiments of inventive concepts. As used herein, the singular forms “a,” “an” and “the” are intended to include the plural forms as well, unless the context clearly indicates otherwise. An expression used in the singular encompasses the expression of the plural, unless it has a clearly different meaning in the context. In the present specification, it is to be understood that the terms such as “including”, “having,” and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added. Expressions such as “at least one of,” when preceding a list of elements, modify the entire list of elements and do not modify the individual elements of the list.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms including technical and scientific terms used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Although corresponding plan views and/or perspective views of some cross-sectional view(s) may not be shown, the cross-sectional view(s) of device structures illustrated herein provide support for a plurality of device structures that extend along two different directions as would be illustrated in a plan view, and/or in three different directions as would be illustrated in a perspective view. The two different directions may or may not be orthogonal to each other. The three different directions may include a third direction that may be orthogonal to the two different directions. The plurality of device structures may be integrated in a same electronic device. For example, when a device structure (e.g., a memory cell structure or a transistor structure) is illustrated in a cross-sectional view, an electronic device may include a plurality of the device structures (e.g., memory cell structures or transistor structures), as would be illustrated by a plan view of the electronic device. The plurality of device structures may be arranged in an array and/or in a two-dimensional pattern.

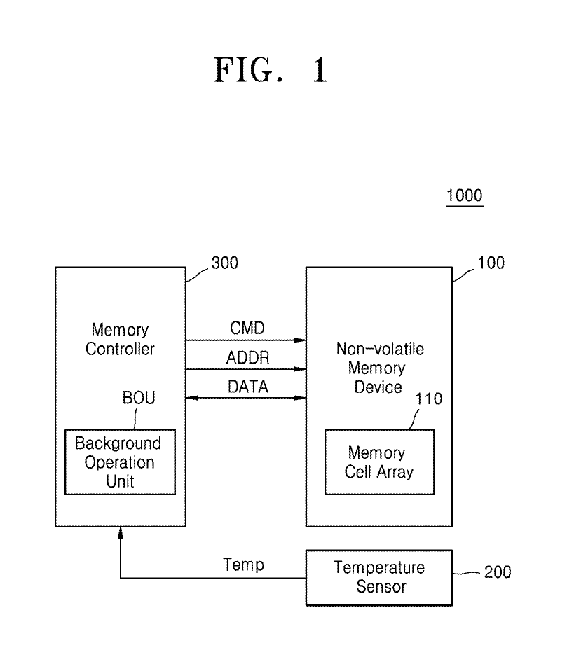

FIG. 1 is a block diagram illustrating a nonvolatile memory system 1000 according to example embodiments of inventive concepts.

The nonvolatile memory system 1000 may be used in various electronic systems, and the electronic system may correspond to various devices. For example, examples of the electronic device may include a smart phone, a tablet PC, a computer, and a TV, but are not limited to these examples. The nonvolatile memory system 1000 may be applied to an embedded memory multimedia card (eMMC), a secure digital (SD) card, a micro SD card, a universal flash storage (UFS), and/or a solid-state drive (SSD), but example embodiments are not limited thereto.

Referring to FIG. 1, the nonvolatile memory system 1000 may include a nonvolatile memory device 100, a temperature sensor 200, and a memory controller 300. The nonvolatile memory system 1000 may store in the nonvolatile memory device 100 data received from a host (not shown) based on an access request from the host, or may read data requested by the host from the nonvolatile memory device 100 and may transmit the data to the host.

The nonvolatile memory device 100 includes a memory cell array 110 including a plurality of nonvolatile memory cells. Examples of the nonvolatile memory device 100 may include a phase-change random-access memory (PRAM), a mask read-only memory (MROM), a programmable read-only memory (PROM), an erasable programmable read-only memory (EPROM), an electrically erasable programmable read-only memory (EEPROM), a read-only memory (ROM), Magnetoresistive random-access memory (MRAM), a magnetic disc, an optical disc, and a flash memory. The flash memory refers to a memory that stores data as a threshold voltage of a MOS transistor changes, and examples of the flash memory may include a NAND flash memory and a NOR flash memory. The following will be explained on the assumption that the nonvolatile memory device 100 is a flash memory.

The temperature sensor 200 may detect an operating temperature of the nonvolatile memory device 100. Also, the temperature sensor 200 may detect a change in a temperature of an environment around the nonvolatile memory device 100, and may measure the changed temperature. Hereinafter, when an operating temperature of the nonvolatile memory device 100 is detected or a change in a temperature of an environment is detected and the changed temperature is measured, it is referred to as measuring a temperature of the nonvolatile memory device 100. The temperature sensor 200 may provide a measured temperature Temp to the memory controller 300.

The memory controller 300 controls an operation of the nonvolatile memory device 100 by applying various signals to the nonvolatile memory device 100. The memory controller 300 applies to the nonvolatile memory device 100 a command CMD and an address ADDR indicating a position to be accessed by the memory cell array 110. Data DATA may be transmitted and received between the memory controller 300 and the nonvolatile memory device 100 based on the command CMD and the address ADDR. Also, the memory controller 300 may apply a clock signal, a chip selection signal, etc. to the nonvolatile memory device 100.

The memory controller 300 may control the nonvolatile memory device 100 to perform a write operation, a read operation, or an erase operation in response to an access request of the host. Also, the memory controller 300 may perform a memory management operation. The memory controller 300 performs the memory management operation in order to manage the nonvolatile memory device 100 to normally operate. The memory controller 300 may determine and perform the memory management operation by itself without a request of the host. The memory management operation performed without the request of the host is referred to as a background operation, and examples of the background operation may include an erase operation, garbage collection, wear levelling, read-refresh, and error check and correction (ECC). If the nonvolatile memory device 100 is flash memory, overwriting may be complex process. In order to overwrite data on the flash memory, original data has to be erased before the data is overwritten, which is referred to as erase-before-write. The flash memory generally performs read/write operations in units of pages, and performs an erase operation in units of blocks that are much larger than those in the write operation. Blocks may be larger than pages. Due to such characteristics of the nonvolatile memory device 100, when the nonvolatile memory device 100 is continuously used, fragmentation may occur and a memory management operation such as garbage collection may be required.

Also, when a write or erase operation is focused on a specific region (e.g., a block or a page) in the memory cell array 110 and thus the degree of wear increases, memory performance may be reduced. When the degree of wear is so high, each memory cell may no longer have data storage capacity. Accordingly, the memory management operation such as wear levelling may be performed in order to maintain a uniform degree of wear in the overall memory cell array 110.

As such, a software or hardware management operation for normally operating the nonvolatile memory device 100 may be performed irrespective of a real access to the nonvolatile memory device 100. For the memory management operation, the memory controller 300 may include a background operation unit (BOU). The BOU may be provided as software in the memory controller 300. Alternatively, the BOU may be provided as hardware. When the nonvolatile memory device 100 is, for example, in an idle state or a sleep state and thus does not perform a storage operation, the memory controller 300 may perform the memory management operation by determining whether it is necessary to perform the memory management operation and whether it is appropriate to perform the memory management operation.

The memory controller 300 may perform the memory management operation based on the temperature Temp of the nonvolatile memory device 100 that is measured by the temperature sensor 200. Operating characteristics of the nonvolatile memory device 100 are affected by a temperature. For example, the possibility that an erase operation succeeds may be high when the erase operation is performed at a specific temperature. Also, the possibility of a read error may respectively increase and decrease as a difference between a writing temperature and a reading temperature increases and decreases. The memory controller 300 may reflect the operating characteristics of the nonvolatile memory device 100 according to a temperature. For example, when the measured temperature Temp of the nonvolatile memory device 100 is in a desired (and/or alternatively predetermined) temperature range, the memory controller 300 may perform the memory management operation and when the measured temperature Temp of the nonvolatile memory device 100 is in a desired temperature range, the memory controller 300 may delay the memory management operation. In this case, the desired (and/or alternatively predetermined) temperature range may be a range of temperatures suitable to perform the memory management operation. Also, when the measured temperature temp of the nonvolatile memory device 100 is in a specific temperature range, the memory controller 300 may perform the memory management operation corresponding to the specific temperature range.

As described above, since the nonvolatile memory system 1000 of FIG. 1 measures a temperature of the nonvolatile memory device 100 and performs or delay the memory management operation based on the measured temperature Temp of the nonvolatile memory device 100, an execution frequency of a memory management operation performed on the nonvolatile memory device 100 may be adjusted and the operational reliability of the nonvolatile memory system 1000 may be improved.

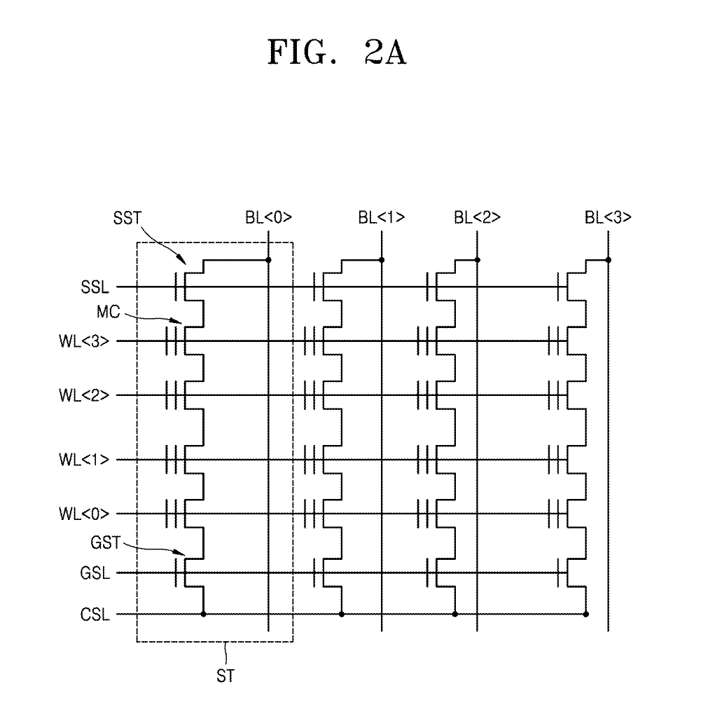

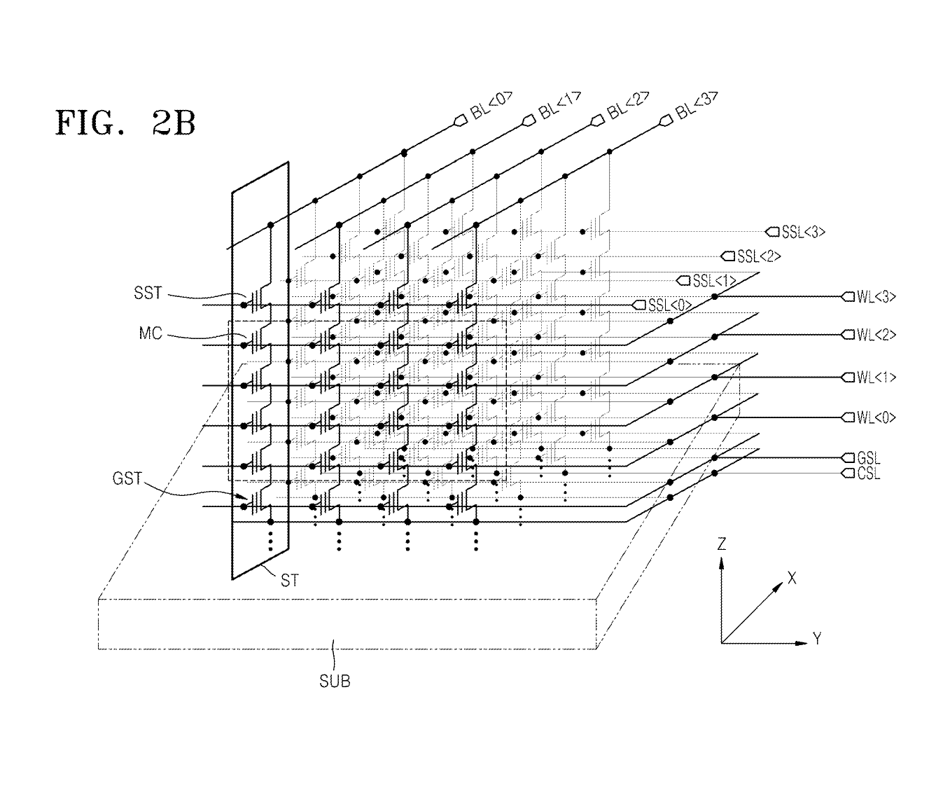

FIGS. 2A and 2B are diagrams illustrating the memory cell array 110 of FIG. 1, according to example embodiments of inventive concepts. The memory cell array 110 of FIG. 1 may be a two-dimensional (2D) NAND flash memory cell array as shown in FIG. 2A. Alternatively, the memory cell array 110 of FIG. 1 may be a vertical NAND flash memory cell array that is three-dimensionally stacked as shown in FIG. 2B.

Referring to FIG. 2A, the memory cell array 110 may include a plurality of memory cell strings ST, word lines WL<0> through WL<3>, and bit lines BL<0> through BL<3>.

A string selection transistor SST that is connected to a string selection line SSL, a plurality of memory cells MC that are respectively connected to the plurality of word lines WL<0> through WL<3>, and a ground selection transistor GST that is connected to a ground selection line GSL. The string selection transistor SST may be connected between one bit line and one string channel, and the ground selection transistor GST may be connected between one string channel and a common source line (CSL).

Referring to FIG. 2B, the memory cell array 110 that is a 3D memory cell array may include a substrate SUB, the plurality of memory cell strings ST, the word lines WL<0> through WL<3>, and the bit lines BL<0> through BL<3>. Each of the memory cell strings ST may extend in a vertical direction Z, in which the memory cell string ST protrudes from the substrate SUB. The memory cell string ST may include the memory cells MC, the source selection transistor SST, and the ground selection transistor GST along the Z-axis. The source selection transistor SST may be connected to source selection lines SSL<0> through SSL<3> that extend in a column direction Y, and may be controlled, and the ground selection transistor GST may be connected to the ground selection line GSL that extends in a row direction X, and the column direction Y and may be controlled.

The word lines WL<0> through WL<3> are arranged in the vertical direction Z that is perpendicular to the substrate SUB. The word lines WL<0> through WL<3> are located on layers where some of the memory cells MC in the memory cell string ST exists. The word lines WL<0> through WL<3> are coupled to the memory cells MC that are arranged in a matrix in the row direction X and the column direction Y over the substrate SUB. The bit lines BL<0> through BL<3> may be connected to memory cell strings ST that are arranged in the row direction X. The memory cells MC, the source selection transistor SST, and the ground selection transistor GST in the memory cell string ST may share the same channel. The channel may be formed to extend in the vertical direction Z that is perpendicular to the substrate SUB.

Continuously, referring to FIGS. 2A and 2B, when an appropriate voltage is applied to the word lines WL<0> through WL<3> and the bit lines BL<0> through BL<3>, a program operation and/or a verify operation may be performed on the memory cells MC. For example, since an arbitrary cell string ST may be selected when a set voltage is applied to the bit lines BL<0> through BL<3> and the source selection lines SSL<0> through SSL<3> that are connected to the selection transistor SST and an arbitrary memory cell MC in the selected memory cell string ST may be selected when a set voltage is applied to the word lines WL<0> through WL<3>, a read, program, and/or verify operation may be performed on the selected memory cell MC.

Each memory cell MC may store 1-bit data or 2-bit or more data. The memory cell MC that stores 1-bit data per memory cell is referred to as a single-level cell (SLC). The memory cell MC that stores 2-bit or more data per memory cell is referred to as a multi-level cell (MLC). The memory cell MC has any one state selected from an erase state and a program state according to a threshold voltage.

Although FIGS. 2A and 2B illustrate examples where each memory cell string ST includes four memory cells MC, example embodiments are not limited thereto. The number of memory cells MC in each memory cell string ST may vary (e.g., greater than 4 or less than 4) and the number of corresponding word lines (e.g, WL<0>) may vary, based on the number of memory cells MC in each memory cell string ST. In other words, the number of word lines (e.g., WL<0>) may be equal to the number of memory cells MC in each memory cell string ST.

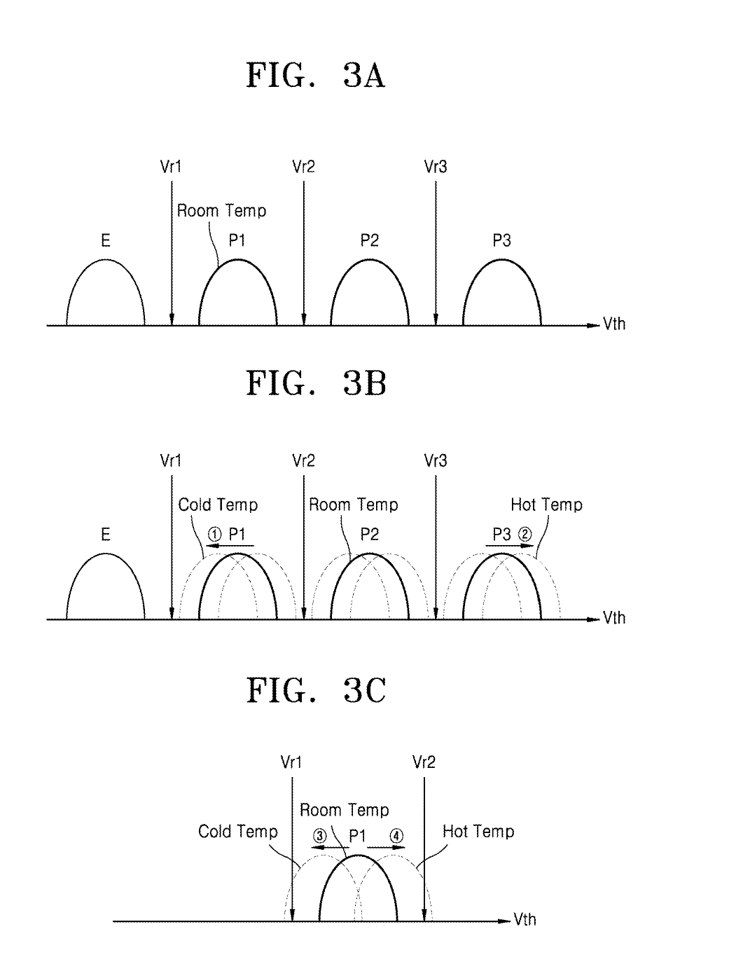

FIGS. 3A through 3C are graphs illustrating a threshold voltage distribution of a memory cell, according to example embodiments of inventive concepts. FIGS. 3A through 3C particularly illustrate an MLC that stores 2-bit data. The threshold voltage distribution of the memory cell of FIG. 3A is a distribution at, for example, a room temperature marked by a solid line. Referring to FIG. 3A, the memory cell has any one selected from among four states, that is, an erase state E, a first program state P1, a second program state P2, and a third program state P3. During a read operation, one voltage selected from among first through third selection read voltages Vr1, Vr2, and Vr3 is supplied to, for example, a selection word line WL1 (see FIG. 2A) and a non-selection read voltage Vread is supplied to, for example, a non-selection word line WL2 (see FIG. 2A). The first selection read voltage Vr1 has a voltage level between the erase state E and the first program state P1, the second selection read voltage Vr2 has a voltage level between the first program state P1 and the second program state P2, and the third selection read voltage Vr3 has a voltage level between the second program state P2 and the third program state P3.

The threshold voltage distribution of the memory cell of FIG. 3B is distribution at a room temperature marked by a solid line, like in FIG. 3A. However, when a program operation is performed at a cold temperature that is lower than the room temperature, the threshold voltage of the memory cell appears to move in a direction marked by an arrow \textcircled{1} to be reduced. For example, in a NAND flash nonvolatile memory device, a potential barrier that allows Fowler-Nordheim (FN) tunneling of the memory cell during the program operation at the cold temperature is reduced. Accordingly, more channel electrons move to a floating gate of the memory cell. In this case, even when a gate voltage of the memory cell is low during a read operation, a channel may be easily formed. Accordingly, the threshold voltage of the memory cell appears to be reduced. Likewise, when a program operation is performed at a hot temperature that is higher than the room temperature, the threshold voltage of the memory cell appears to move in a direction marked by an arrow \textcircled{2} to be increased.

If a program operation is performed at a cold temperature and a read operation is performed at a room temperature, a read margin of a flash nonvolatile memory device is reduced. When the first through third selection read voltages Vr1, Vr2, and Vr3 are assumed to be constant in FIG. 3B, when the threshold voltage of the memory cell moves to the left, a read margin is accordingly reduced. Likewise, even when a program operation is performed at a hot temperature and a read operation is performed at a reference temperature, a read margin of the flash nonvolatile memory device is reduced.

FIG. 3C is a graph illustrating a threshold voltage distribution of a memory cell with a read failure, according to example embodiments of inventive concepts. FIG. 3C illustrates the first program state P1, the first selection read voltage Vr1, and the second selection read voltage Vr2. When it is assumed that the first selection read voltage Vr1 and the second selection read voltage Vr2 are constant and a read operation is performed at a room temperature, when a program operation is performed at a cold temperature and the threshold voltage of the memory cell moves in a direction marked by an arrow \textcircled{3} to be reduced, a read failure may occur. Also, even when a program operation is performed at a hot temperature and the threshold voltage of the memory cell moves in a direction marked by an arrow \textcircled{4} to be increased, a read failure may occur.

As described above, since a threshold value when the memory cell MC is programmed varies according to a temperature, operating characteristics of the nonvolatile memory device 100 may be affected by the temperature. The operational reliability may be improved by considering a temperature of the nonvolatile memory device 100 during a memory management operation as well as a write operation and a read operation.

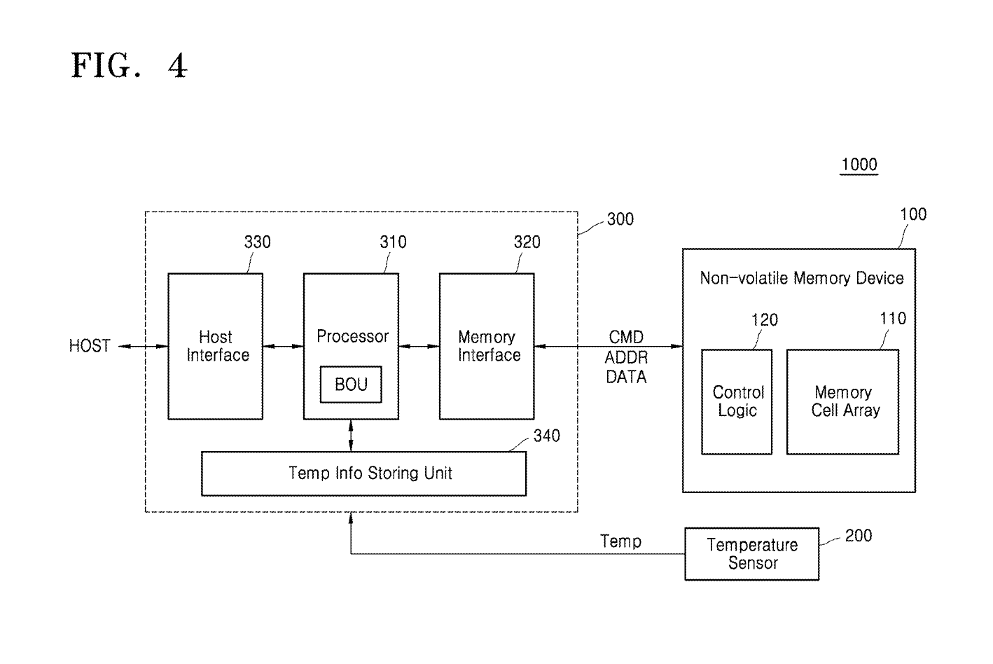

FIG. 4 is a block diagram illustrating the nonvolatile memory system 1000 of FIG. 1, according to example embodiments of inventive concepts.

Referring to FIG. 4, the nonvolatile memory system 1000 may include the nonvolatile memory device 100, the temperature sensor 200, and the memory controller 300.

The nonvolatile memory device 100 may include the memory cell array 110 and a control logic 120. The memory cell array 110 may have a memory cell structure of FIG. 2A or 2B, or may include various other types of memory cells.

The control logic 120 may perform an operation of the memory cell array 110 according to the command CMD, the address ADDR, or the data DATA received from the memory controller 300. For example, the control logic 120 may read or write the data DATA from or to the memory cell array 110, or may erase a region of the memory cell array 110, based on various commands such as a read command, a write command, and an erase command received from the memory controller 300. To this end, although not shown in FIG. 4, the nonvolatile memory device 100 may further include a decoder (not shown) for selecting the memory cell MC corresponding to the address ADDR, a driver (not shown) for applying an operating voltage to the word line WL to perform an operation according to the command CMD on the selected memory cell MC, a voltage generation unit (not shown) for generating the operating voltage, and a data input/output unit (not shown) for receiving or transmitting the data DATA.

The temperature sensor 200 may measure a temperature of the nonvolatile memory device 100 and may provide the measured temperature Temp to the memory controller 300. The temperature sensor 200 may periodically measure the temperature, or may measure the temperature when there is a request from the memory controller 300. For example, the temperature sensor 200 may include a temperature detection element such as a thermistor.

The memory controller 300 may include a processor 310, a memory interface 320, a host interface 330, and a temperature information storage unit 340. Alternatively, the temperature information storage unit 340 may be separately provided from the memory controller 300.

The host interface 330 includes a data exchange protocol for data exchange with a host HOST that is connected to the nonvolatile memory system 1000, and establishes a connection between the nonvolatile memory system 1000 and the host HOST. The host interface 330 may communicate with the host HOST under the control of the processor 310. Examples of the host interface 330 may include, but are not limited to, an eMMC interface, an UFS interface, an SD interface, a serial advanced technology attachment (SATA) interface, a serial attached small computer system interface (SCSI), an advanced technology attachment (ATA) interface, a parallel advanced technology attachment (PATA) interface, an NVM express (NVMe), and a universal serial bus (USB).

The memory interface 320 may transmit the command CMD, the address ADDR, and the data DATA to the nonvolatile memory device 100, and may receive the data DATA according to the command CMD requested from the nonvolatile memory device 100. Also, the memory interface 320 may transmit to the nonvolatile memory device 100 the command CMD corresponding to a memory management operation (for example, garbage collection or wear leveling) of the memory controller 300 or the command CMD generated from the processor 3410 in response to a request of the host HOST.

The processor 310 may control an overall operation of the nonvolatile memory system 1000 including the memory controller 300. The processor 310 may transmit/receive necessary signals to/from the host HOST and the nonvolatile memory device 100 via the host interface 330 and the memory interface 320. Also, the processor 310 may perform the memory management operation. The BOU may be firmware and may operate under the control of the processor 310. The processor 310 may perform the memory management operation such as an erase operation, garbage collection, or ECC by using the BOU.

The temperature information storage unit 340 may store temperature information that is needed to operate the nonvolatile memory device 100 such as a temperature range suitable for the memory management operation or a temperature when the nonvolatile memory device 100 operates. For example, when data is written to a region of the memory cell array 110 according to a request of the host HOST, temperature information during a data write operation may be stored in the temperature information storage unit 340. Since a write operation is performed in units of pages in a flash memory, temperature information during a write operation on each written page may be stored in the temperature information storage unit 340. Also, a temperature range suitable for the memory management operation may be stored. The temperature range may be set by being experimentally obtained and set in a step of manufacturing the nonvolatile memory device 100 or a test step, or may be set by a user. Also, the temperature range may be set based on the temperature information during the write operation.

The BOU may receive information about the temperature range suitable for the memory management operation from the temperature information storage unit 340, and may determine whether the measured temperature Temp that is received from the temperature sensor 200 is included in the temperature range. When the measured temperature Temp is included in the temperature range, the BOU may perform the memory management operation, and when the measured temperature Temp is not included in the temperature range, the BOU may delay the memory management operation. For example, the processor 310 may adjust a temperature of the nonvolatile memory device 100 to include the measured temperature Temp in the temperature range. The processor 310 may adjust the temperature of the nonvolatile memory device by changing a reference clock signal applied to the nonvolatile memory device 100 to change a normal operation frequency of the nonvolatile memory device 100. However, it is a non-limiting example and example embodiments are not limited thereto. The processor 310 may adjust the temperature of the nonvolatile memory device 100 by using a heating element or a heat dissipation element, or by using any of other methods.

When the measured temperature Temp of the nonvolatile memory device 100 is not included in the temperature range suitable for the memory management operation, the BOU may determine whether to delay the memory management operation in consideration of a resource of the nonvolatile memory device 100. For example, the resource of the nonvolatile memory device 100 may be a capacity of an empty space of the nonvolatile memory device 100 where data is to be stored. Assuming that the memory management operation for generating free blocks such as an erase operation or garbage collection is performed, when free blocks are insufficient and the memory management operation needs to be performed immediately, the memory management operation may be performed even though the measured temperature Temp is not included in the temperature range. When it is determined that the free blocks are sufficient, the memory management operation may be delayed until the measured temperature Temp reaches the temperature range suitable for the memory management operation.

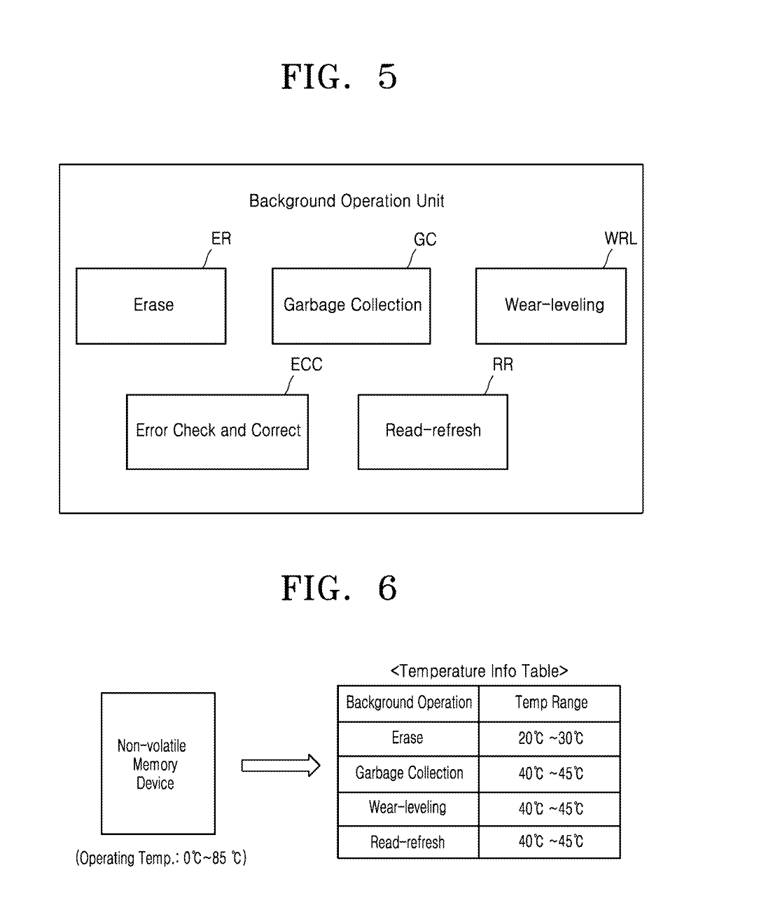

The BOU may receive information about a temperature range suitable for each memory management operation from the temperature information storage unit 340, and may perform the memory management operation corresponding to the temperature range including the measured temperature Temp of the nonvolatile memory device 100. The memory management operation based on the measured temperature Temp of the nonvolatile memory device 100 will be explained in more detail with reference to FIGS. 5 through 7B.

FIG. 5 is a block diagram illustrating the BOU of FIG. 1, according to example embodiments of inventive concepts.

Referring to FIG. 5, the BOU may include an erase functional block ER, a garbage collection functional block GC, a wear leveling functional block WRL, an ECC functional block ECC, and a read-refresh functional block RR. The BOU may be provided as hardware or software, and may be provided as firmware as described above.

The erase functional block ER erases data written to memory cells in units of blocks. When the measured temperature Temp of the nonvolatile memory device 100 reaches a temperature or a temperature range suitable for an erase operation, the erase functional block ER may perform the erase operation. For example, when the nonvolatile memory device 100 has the best erase characteristics at a temperature of 25° C., the erase functional block ER may store information about blocks to be erased, and when the measured temperature Temp of the nonvolatile memory device 100 received from the temperature sensor 200 is about 25° C. or reaches a temperature range including 25° C., the erase function block ER may issue the command CMD to perform an erase operation on the blocks.

The garbage collection functional block GC may copy to one block a plurality of pieces of page-unit data that are stored in a plurality of blocks of the memory cell array 110 after being fragmentized, may erase the blocks in which the pieces of page-unit data are stored, and may generate free blocks. The garbage collection functional block GC may perform a garbage collection operation when the measured temperature Temp of the nonvolatile memory device 100 reaches a temperature or a temperature range suitable for garbage collection. For example, when it is assumed that an operating temperature range of the nonvolatile memory device 100 is from about 0° C. to about 85° C., the temperature suitable for the garbage collection may range from about 40° C. to about 45° C. When a difference between a temperature during a write operation and a temperature during a read operation in the nonvolatile memory device 100 is high, the possibility that a read error occurs is high. When a garbage collection operation is performed, a write operation is performed. Hence, the garbage collection operation may be performed in a temperature range corresponding to the middle of the operating temperature range of the nonvolatile memory device 100 so that a maximum difference between a temperature during a read operation and a temperature during a write operation during the garbage collection operation is less than 45° C. However, it is a non-limiting example and example embodiments are not limited thereto, and the temperature or the temperature range suitable for the garbage collection may vary according to operating characteristics of the nonvolatile memory device 100 or the user's selection.

The wear leveling functional block WRL may count the number of write operations performed on each region (e.g., a block or a page) of the memory cell array 110, and may change a mapping relationship between a logical address and a physical address for a region having a large number of write operations to adjust the number of write operations of memory cells. The wear leveling functional block WRL may adjust the number of write operations of the memory cells by using any of various methods, for example, by copying data that is stored in the region having the large number of write operations to another region and processing the region as an invalid region. The wear leveling functional block WRL may perform a wear leveling operation when the measured temperature temp of the nonvolatile memory device 100 reaches a temperature or a temperature range suitable for wear leveling. For example, when data that is stored in a region of the memory cell array 110 is copied to another region during a wear leveling operation, a temperature range corresponding to the middle of an operating temperature range of the nonvolatile memory device 100 may be set as the temperature range suitable for wear leveling, like in a garbage collection operation. However, it is a non-limiting example and example embodiments are not limited thereto.

The ECC functional block ECC may check data written to a memory cell, and when an error occurs, may correct the error by using any of various error correction units. The ECC functional block ECC may perform an ECC operation when the measured temperature Temp of the nonvolatile memory device 100 reaches a temperature or a temperature range during a write operation performed on a memory cell region whose error is to be checked. Alternatively, when it is checked that an uncorrectable error occurs in the memory cell region, the ECC functional block ECC may re-perform an ECC operation when a temperature or a temperature range during a write operation performed on the memory cell region is reached. For example, when a specific page on which a write operation has been performed at 80° C. is read and it is determined that an uncorrectable error occurs, the ECC functional block ECC may periodically measure a temperature of the nonvolatile memory device 100 by using the temperature sensor 200, and may re-perform an ECC operation when the measured temperature reaches about 80° C. Information about a temperature during a write operation performed on the specific page may be stored in the temperature information storage unit 340 (see FIG. 4) whenever the write operation is performed, and the ECC functional block ECC may use the temperature information when an ECC operation is performed. Since the possibility of a read error decreases as a difference between a temperature during a write operation and a temperature during a read operation decreases, the possibility of error correction may be increased by performing an ECC operation at a temperature or in a temperature range when a write operation is performed on a memory cell region.

The read-refresh functional block RR may count the number of read operations performed on each region (e.g., a block or a page) of the memory cell array 110, may copy data for a region having a large number of read operations to another region, and may change a mapping relationship between a logical address and a physical address to adjust the number of read operations of memory cells. The read-refresh functional block RR may perform a read-refresh operation when the measured temperature Temp of the nonvolatile memory device 100 reaches a temperature or a temperature range suitable for a read-refresh operation. For example, a temperature range corresponding to the middle of an operating temperature range of the nonvolatile memory device 100 may be set as a temperature range suitable for a read-refresh operation. However, it is a non-limiting example and example embodiments are not limited thereto. A temperature range may be set in consideration of characteristics of a read-refresh operation and operating characteristics of the nonvolatile memory device 100.

As described above, the BOU may include various functional blocks for performing memory management operations, and may perform the memory management operations when a temperature of the nonvolatile memory device 100 reaches a temperature or a temperature range suitable for the memory management operations. Although 5 memory management operations are described in FIG. 5, the BOU may include various other functional blocks and may perform more memory management operations than the 5 examples described in FIG. 5.

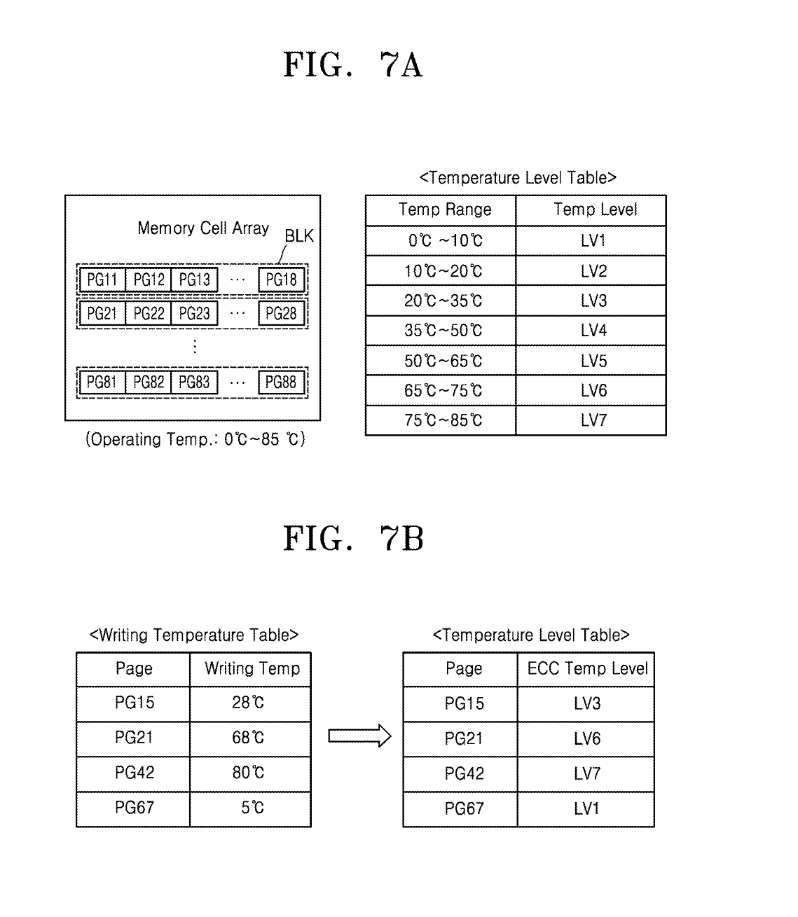

FIG. 6 is a temperature information table showing a temperature range suitable for a memory management operation, according to example embodiments of inventive concepts.

Referring to FIG. 6, when an operating temperature range of the nonvolatile memory device 100 is from about 0° C. to about 85° C., a temperature range corresponding to each memory management operation, for example, a background operation, may be set within the operating temperature range. The temperature information table shows the temperature range corresponding to the background operation. Information about the temperature range corresponding to each memory management operation may be stored in a register provided in the processor 310 or the temperature information storage unit 340 (see FIG. 4). Although an example of a temperature range is described in FIG. 6, the example embodiments are not limited thereto. The temperature range corresponding to each memory management operation may be set according to characteristics of each memory management operation and operating characteristics of the nonvolatile memory device 100. The temperature range suitable for each memory management operation may be experimentally obtained in a step of manufacturing the nonvolatile memory device 100 or may be set by the user.

FIGS. 7A and 7B are diagrams for explaining a method of setting temperature information in order to perform an ECC operation as a memory management operation, according to example embodiments of inventive concepts. FIG. 7A illustrates the memory cell array 110 of the nonvolatile memory device 100 (see FIG. 1) and information obtained by dividing a temperature range according to steps. FIG. 7B illustrates information about a writing temperature of pages and an ECC temperature range for the pages.

Referring to FIG. 7A, the memory cell array 110 of the nonvolatile memory device 100 may include a plurality of blocks BLK, and the blocks BLK may include a plurality of pages PG11 through PG88. Although 8 blocks and 8 pages are illustrated in FIG. 7A, it is a non-limiting example and example embodiments are not limited thereto. The number of blocks and pages may be determined according to a capacity of the memory cell array 110. A write operation and a read operation of the nonvolatile memory device 100 may be performed in units of pages, and an erase operation of the nonvolatile memory device 100 may be performed in units of the blocks BLK.

An operating temperature range in which the nonvolatile memory device 100 may normally perform a storage operation may be set. For example, the operating temperature range of the nonvolatile memory device 100 may be from about 0° C. to about 85° C. The operating temperature range of the nonvolatile memory device 100 may be divided into a plurality of temperature ranges. Referring to a temperature level table, the operating temperature range between about 0° C. and about 85° C. may be divided into temperature ranges of 7 levels. However, it is a non-limiting example and example embodiments are not limited thereto, and the operating temperature range may be divided by the user in various ways. For example, all of temperature ranges may have same interval and each of temperature ranges may not be continuous.

Referring to FIG. 7B, a writing temperature may be stored for each of written pages, and a temperature range level of an ECC operation for each of the written pages may be determined based on the writing temperature for each of the written pages. For example, since a writing temperature of a page 15 is 28° C. and 28° C. is included in a level 3 LV3, an ECC operation for the page 15 may be performed in a temperature range of the level 3 LV3. When a measured temperature of the nonvolatile memory device 100 (see FIG. 1) corresponds to the level 3 LV3, for example, is between about 20° C. and about 35° C., an ECC operation for the page 15 may be performed.

A temperature range, a writing temperature for each of pages, and a temperature level of an ECC operation set in FIGS. 7A and 7B may be stored in the temperature storage unit 340 (see FIG. 4) or may be stored in the register provided in the processor 310. Also, the information may be stored in the memory cell array 110 of the nonvolatile memory device 100. The stored information may be loaded onto the processor 310 (see FIG. 4) and may be used during a memory management operation.

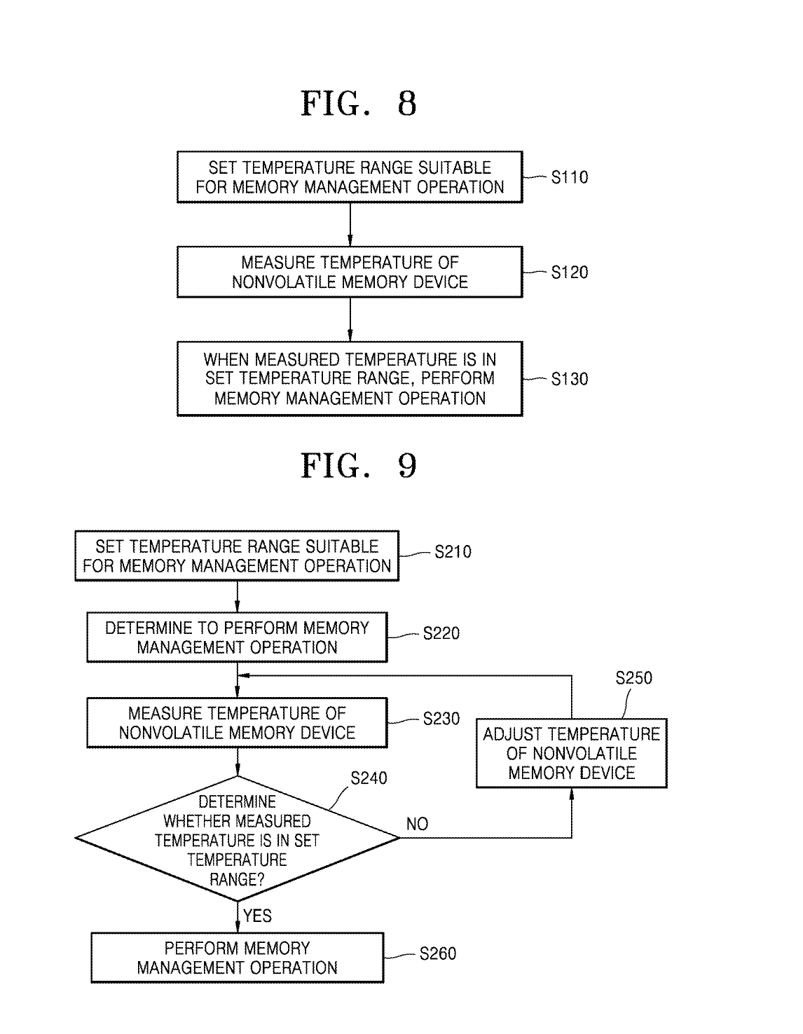

FIG. 8 is a flowchart illustrating a method of operating the nonvolatile memory device 100, according to example embodiments of inventive concepts.

Referring to FIG. 8, first, in operation S110, a temperature range suitable for a memory management operation is set. The temperature range suitable for the memory management operation may be set in a step of manufacturing the nonvolatile memory device 100 (see FIG. 1) or a step of setting up the nonvolatile memory device 100. Also, when the memory management operation such as an ECC operation is affected by a temperature during a specific operation of the nonvolatile memory device 100, the temperature range suitable for the memory management operation may be set when the specific operation is performed. The suitable temperature range may vary according to a type of the memory management operation.

In operation S120, a temperature of the nonvolatile memory device 100 is measured. The temperature of the nonvolatile memory device 100 may be periodically measured by using the temperature sensor 200 (see FIG. 1). Alternatively, when there is a request from the memory controller 300, the temperature may be measured. The measured temperature is provided to the memory controller 300.

When the measured temperature is included in the set temperature range, in operation S130, the memory management operation is performed. The memory management operation may be mainly performed when the nonvolatile memory device 100 is in an idle state or a sleep state and thus does not perform a storage operation according to an access request of a host. In this case, for operational reliability, when the measured temperature is included in the set temperature range suitable for the memory management operation, the memory management operation may be performed.

FIG. 9 is a flowchart illustrating a method of operating the nonvolatile memory device 100, according to example embodiments of inventive concepts. The method of FIG. 9 is a modification of the method of FIG. 8.

Referring to FIG. 9, in operation S210, a temperature range suitable for a memory management operation is set. In operation S220, the memory management operation is determined to be performed. The memory management operation may be determined to be performed when the nonvolatile memory device 100 (see FIG. 1) is in an idle state or a sleep state. The memory controller 300 (see FIG. 1) may determine the memory management operation to be performed.

When the memory management operation is determined to be performed, the method proceeds to operation S230. In operation S230, a temperature of the nonvolatile memory device 100 is measured. The temperature of the nonvolatile memory device 100 may be measured by using the temperature sensor 200 (see FIG. 1). In operation S240, it is determined whether the measured temperature is included in the set temperature range. For example, the memory controller 300 (see FIG. 1) may determine whether the measured temperature is included in the set temperature range. When it is determined in operation S240 that the measured temperature is included in the set temperature range, the method proceeds to operation S260. In operation S260, the memory management operation is performed. The memory controller 300 (see FIG. 1) may control the performance of the memory management operation on the nonvolatile memory device 100.

When the measured temperature is not included in the set temperature range, the memory management operation may be delayed. In this case, in operation S250, the temperature of the nonvolatile memory device 100 may be adjusted. For example, the temperature of the nonvolatile memory device 100 may be adjusted by causing the memory controller 300 (see FIG. 1) to increase or decrease an operation speed of the nonvolatile memory device 100. Alternatively, the memory controller 300 may adjust the temperature of the nonvolatile memory device 100 by using a heating element or a heat dissipation element.

Next, the method refers to operation S230. In operation S230, the temperature of the nonvolatile memory device 100 is re-measured. The temperature of the nonvolatile memory device 100 may be re-measured using the temperature sensor 200 (see FIG. 1). When the re-measured temperature is included in the set temperature range, the method proceeds to operation S260. In operation S260, the memory management operation is performed.

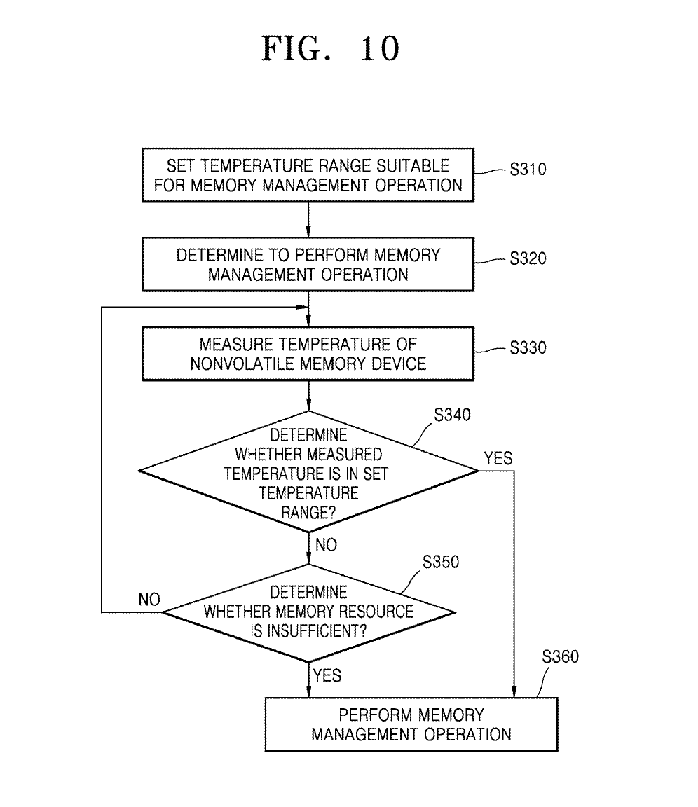

FIG. 10 is a flowchart illustrating a method of operating the nonvolatile memory device 100, according to example embodiments of inventive concepts. The method of FIG. 10 is a modification of the method of FIG. 8.

Referring to FIG. 10, in operation S310, a temperature range suitable for a memory management operation is set. In operation S320, the memory management operation is determined to be performed. In operation S330, a temperature of the nonvolatile memory device 100 is measured. In operation S340, it is determined whether the measured temperature is included in the set temperature range. When it is determined in operation S340 that the measured temperature is included in the set temperature range, the method proceeds to operation S360. In operation S360, the memory management operation is performed. When it is determined in operation S340 that the measured temperature is not included in the set temperature range, the method proceeds to operation S350. In operation S350, it is determined whether a memory resource is sufficient. For example, the memory controller 300 (see FIG. 1) may determine whether a memory resource is sufficient. When it is determined in operation S350 that the memory resource is sufficient, the memory management operation may be delayed in consideration of operational reliability. In operation S330, the temperature of the nonvolatile memory device 100 is periodically measured. When the measured temperature is included in the set temperature range, the method proceeds to operation S360. In operation S360, the memory management operation is performed. In contrast, when it is determined that the memory resource is not sufficient, the method proceeds to operation S360. In operation S360, the memory management operation is performed to perform a normal storage operation. For example, the memory management operation may be an operation for obtaining free blocks such as garbage collection or an erase operation.

According to the method, when a memory management operation for performing a normal operation has to be performed immediately, for example, when a memory resource is insufficient, although a measured temperature is not include in a set temperature range, the memory management operation is performed, thereby limiting and/or preventing the performance of the nonvolatile memory device 100 from being reduced.

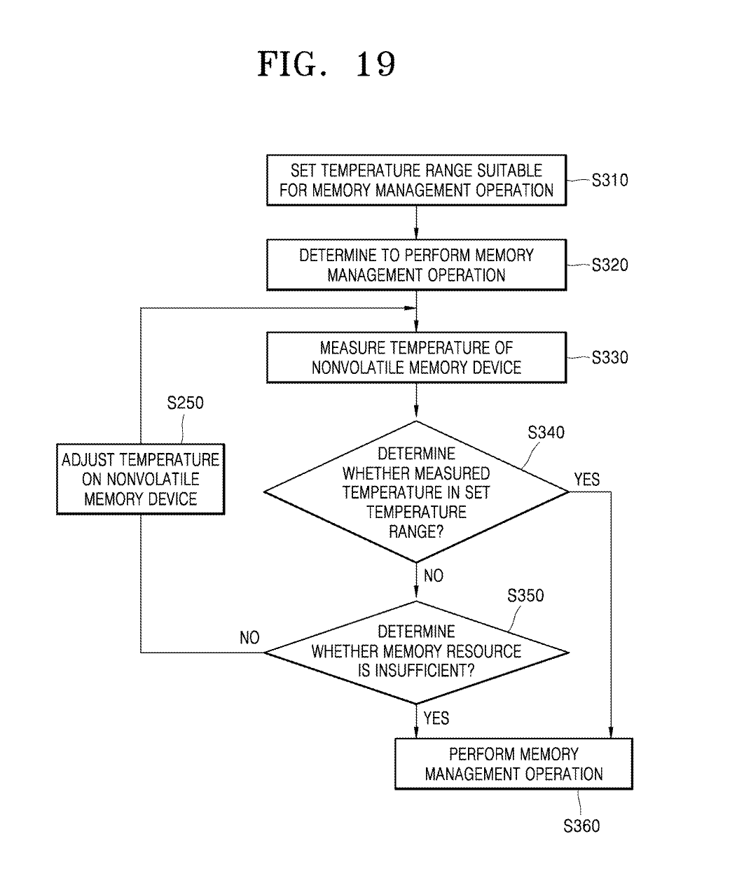

FIG. 19 is a flowchart illustrating a method of operating the nonvolatile memory device, according to example embodiments of inventive concepts.

Referring to FIG. 19, the method illustrated in FIG. 19 is the same as the method illustrated in FIG. 10, except the method further includes operation S250 from FIG. 9. In operation S350, a memory controller may determine whether the memory resource is sufficient. If the memory controller determines that the memory resource is sufficient, the memory controller may delay the memory management operation and adjust the temperature of the nonvolatile memory device according to operation S250. For example, the temperature of the nonvolatile memory device 100 may be adjusted by causing the memory controller 300 (see FIG. 1) to increase or decrease an operation speed of the nonvolatile memory device 100. Alternatively, the memory controller 300 may adjust the temperature of the nonvolatile memory device 100 by using a heating element or a heat dissipation element. After adjusting the temperature of the nonvolatile memory device, the memory controller 300 may measure the temperature of the nonvolatile memory device according to operation S330 and then proceed to operation S340.

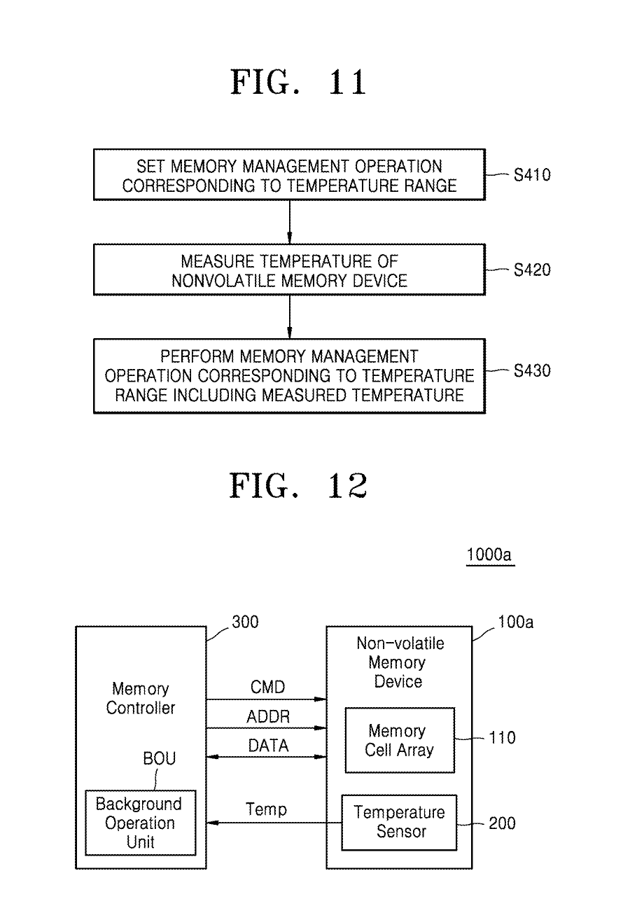

FIG. 11 is a flowchart illustrating a method of operating the nonvolatile memory device 100, according to example embodiments of inventive concepts.

Referring to FIG. 11, in operation S410, a memory management operation corresponding to each temperature range is set. As described with reference to FIG. 6, a temperature range suitable for each memory management operation may be set. In this case, the temperature range may be set in consideration of characteristics of the memory management operation and operating characteristics of the nonvolatile memory device 100.

Next, in operation S420, a temperature of the nonvolatile memory device is measured. In operation S430, the memory management operation corresponding to a temperature range including the measured temperature may be performed. For example, assuming that a temperature range corresponding to a garbage collection operation is set to be from about 40° C. to about 45° C. and a temperature range corresponding to an ECC operation for a specific page of the memory cell array 110 is set to be from about 70° C. to about 85° C., when a measured temperature of the nonvolatile memory device 100 is 43° C., the garbage collection operation may be performed. Alternatively, when the measured temperature of the nonvolatile memory device 100 is about 80° C., the ECC operation for the specific page may be performed.

FIG. 12 is a block diagram illustrating a nonvolatile memory system 1000a according to example embodiments of inventive concepts.

Referring to FIG. 12, the nonvolatile memory system 1000a may include a nonvolatile memory device 100a and the memory controller 300. The nonvolatile memory device 100a may include the memory cell array 110 and the temperature sensor 200.

The memory controller 300 may include the BOU, and may perform a memory management operation based on the measured temperature Temp of the nonvolatile memory device 100a received from the temperature sensor 200. The memory controller 300 may perform a memory management operation when the measured temperature Temp is included in a desired (and/or alternatively predetermined) temperature range. Alternatively, the memory controller 300 may store information about the memory management operation corresponding to each temperature range, and may perform the memory management operation corresponding to a temperature range including the measured temperature Temp.

Although the nonvolatile memory system 1000a includes one nonvolatile memory device 100a in FIG. 12, example embodiments are not limited thereto. The nonvolatile memory system 1000a may include a plurality of the nonvolatile memory devices 100a that are controlled by the memory controller 300, and each of the plurality of nonvolatile memory devices 100a may include the memory cell array 110 and the temperature sensor 200. The memory controller 300 may perform the memory management operation on each of the nonvolatile memory devices 100a based on the measured temperature Temp received from the temperature sensor 200 of the nonvolatile memory device 100a.

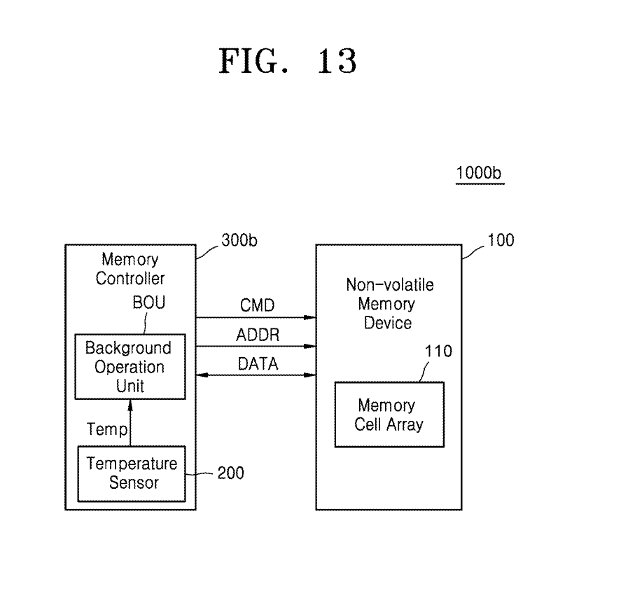

FIG. 13 is a block diagram illustrating a nonvolatile memory system 1000b according to example embodiments of inventive concepts.

Referring to FIG. 13, the nonvolatile memory system 1000b may include the nonvolatile memory device 100 and a memory controller 300b. The temperature sensor 200 of FIG. 13 may be provided in the memory controller 300b. The memory controller 300b may be disposed adjacent to the nonvolatile memory device 100, and may measure a temperature of an environment around the nonvolatile memory device 100 by using the temperature sensor 200 that is provided in the memory controller 300b. The memory controller 300b may perform a memory management operation based on the measured temperature Temp. Other operations are the same as those of the nonvolatile memory system 1000 of FIG. 1, and thus a repeated explanation thereof will not be given.

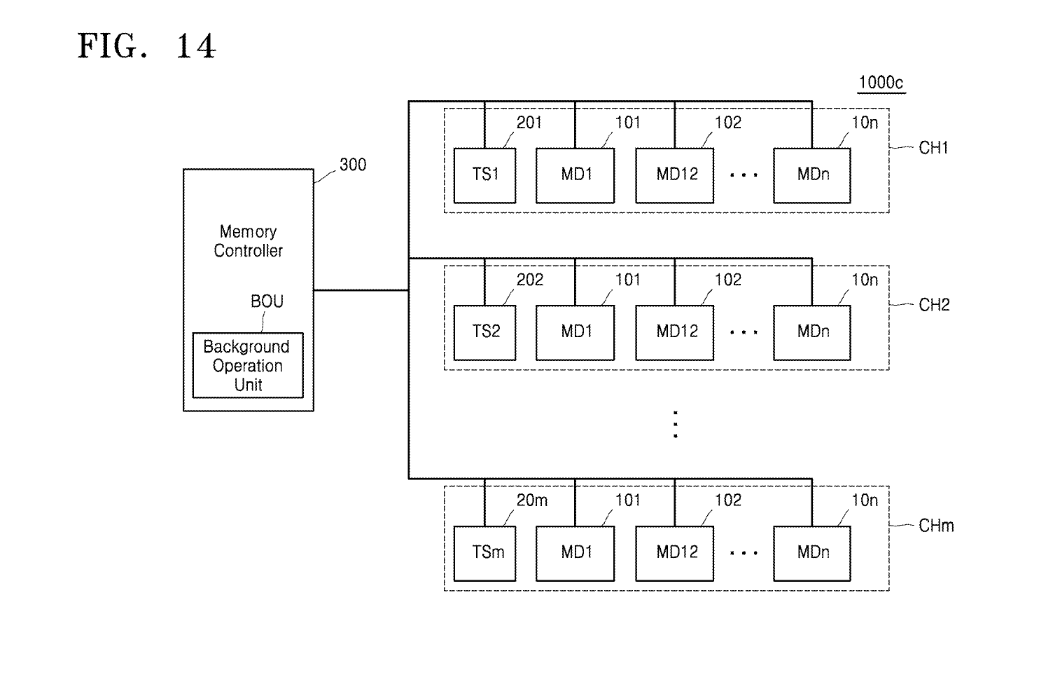

FIG. 14 is a block diagram illustrating a nonvolatile memory system 1000c according to example embodiments of inventive concepts.

Referring to FIG. 14, the nonvolatile memory system 1000c may include a plurality of channels CH1 through CHm each of which includes a plurality of nonvolatile memory devices MD1 through MDn, and the memory controller 300 that controls the plurality of channels CH1 through CHm.

The plurality of nonvolatile memory devices MD1 through MDn may be provided in each of the plurality of channels CH1 through CHm and temperature sensors 201 through 20m may be respectively provided in the plurality of channels CH1 through CHm. The temperature sensor 200 may a temperature of each of the channels CH1 through CHm and may provide the temperature to the memory controller 300.

The memory controller 300 may store the temperature according to each of the channels CH1 through CHm and may perform a memory management operation. For example, when the measured temperature received from the temperature sensor 201 of the first channel CH1 is included in a desired (and/or alternatively predetermined) temperature range, the memory controller 300 may perform a memory management operation corresponding to the temperature range for the nonvolatile memory devices 101 through 10n. The memory management operation may be sequentially or simultaneously performed on the plurality of channels CH1 through CHm.

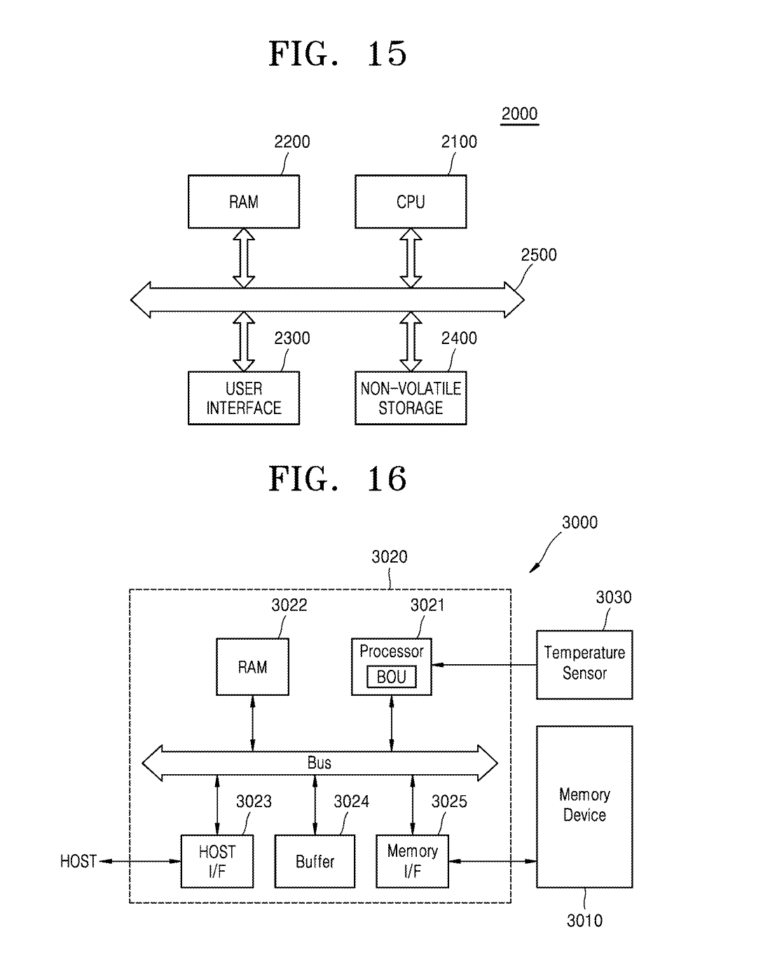

FIG. 15 is a block diagram illustrating a computing system 2000 to which a nonvolatile memory system is applied, according to example embodiments of inventive concepts.

Any of the above-described nonvolatile memory systems according to example embodiments of inventive concepts may be mounted as a nonvolatile storage device 2400 on the computing system 2000 such as a mobile device or a desktop computer.

The computing system 2000 of FIG. 15 may include a central processing unit (CPU) 2100, a RAM 2200, a user interface 2300, and the nonvolatile storage device 2400, which may be electrically connected to a bus 2500. Examples of a nonvolatile memory device included in the nonvolatile storage device 2400 may include a NAND flash memory, a NOR flash memory, an MRAM, a resistive RAM (RRAM), a ferroelectric RAM (FRAM), and a phase-change memory (PCM).

In example embodiments, the nonvolatile storage device 2400 may include a memory controller, the nonvolatile memory device, and a temperature sensor that measures a temperature of the nonvolatile memory device. The memory controller may perform a memory management operation based on the temperature of the nonvolatile memory device measured by the temperature sensor. The memory controller may perform the memory management operation when the measured temperature is included in a desired (and/or alternatively predetermined) temperature range. Also, the memory controller may set a temperature range according to each memory management operation, and may perform the memory management operation corresponding to a temperature range including the measured temperature.

FIG. 16 is a block diagram illustrating an SSD 3000 according to example embodiments of inventive concepts.

Referring to FIG. 16, the SSD 3000 includes a nonvolatile memory device 3010, an SSD controller 3020, and a temperature sensor 3030. The temperature sensor 3030 may be provided in the nonvolatile memory device 3010, or may be provided in the SSD controller 3020. The SSD controller 3020 may be the memory controller 300 of FIG. 1, the nonvolatile memory device 3010 may be the nonvolatile memory device 100 of FIG. 1, and the temperature sensor 3030 may be the temperature sensor 200 of FIG. 1.

The SSD controller 3020 may include a processor 3021, a RAM 3022, a host interface 3023, a cache buffer 3024, and a memory interface 3025. The processor 3021 controls the memory interface 3025 to transmit/receive data to/from the nonvolatile memory device 3010 in response to a request (e.g., a command, an address, or data) of a host (not shown). The processor 3021 and the memory interface 3025 of the SSD controller 3020 may be embodied as one ARM processor. Data necessary to operate the processor 3021 may be loaded onto the RAM 3022.

The processor 3021 performs a memory management operation on the nonvolatile memory device 3010. The processor 3021 may include the BOU, and may perform the memory management operation based on a temperature of the nonvolatile memory device 3010 measured by the temperature sensor 3030.

The host interface 3023 receives the request of the host and transmits the request to the processor 3021, or may transmit data received from the nonvolatile memory device 3010 to the host. The host interface 3023 may interface with the host via any of various interface protocols such as USB, man machine communication (MMC), peripheral component interconnect-express (PCI-E), SATA, PATA, SCSI, enhanced small device interface (ESDI), and intelligent drive electronics (IDE). Data to be transmitted to the nonvolatile memory device 3010 or received from the nonvolatile memory device 3010 may be temporarily stored in the cache buffer 3024. The cache buffer 3024 may be a static random-access memory (SRAM).

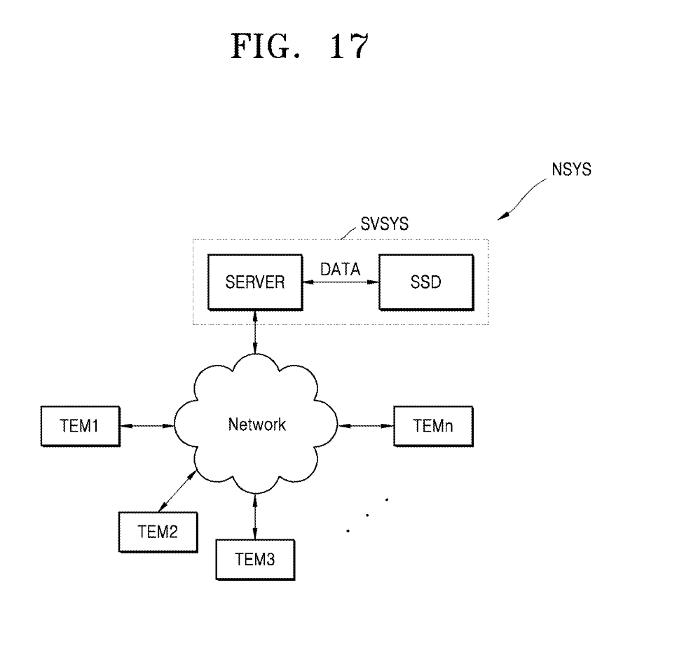

FIG. 17 is a diagram illustrating a network system NSYS and a server system SVSYS including the SSD 3000 of FIG. 16, according to example embodiments of inventive concepts.

Referring to FIG. 17, the network system NSYS may include the server system SVSYS and a plurality of terminals TEM1 through TEMn that are connected through a network. The server system SVSYS may include a server SERVER that processes a request received from each of the plurality of terminals TEM1 through TEMn that are connected to the network, and the SSD 3000 that stores data DATA corresponding to the request received from each of the terminals TEM1 through TEMn. The network system NSYS and the server system SVSYS may ensure high operational reliability. The SERVER can transfer DATA to the SSD 3000. The SERVER may read DATA from the SSD 3000.

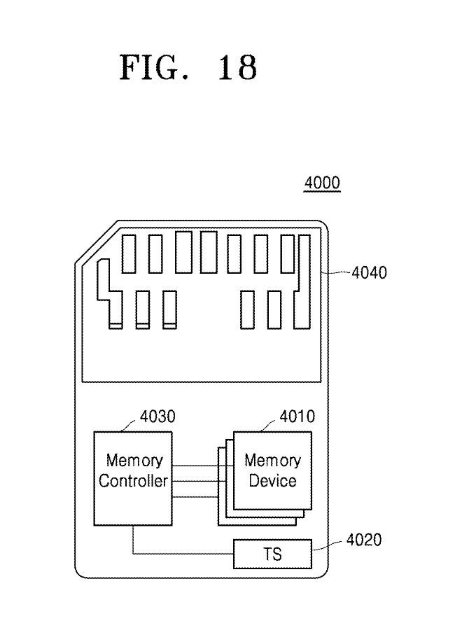

FIG. 18 is a diagram illustrating a memory card 4000 according to example embodiments of inventive concepts. The memory card 4000 may be a portable storage device that may be connected to an electronic device such as a mobile device or a desktop computer. As shown in FIG. 18, the memory card 4000 may include a memory controller 4030, a nonvolatile memory device 4010, a temperature sensor 4020, and a port region 4040. The temperature sensor 4020 may be provided in the nonvolatile memory device 4010 or the memory controller 4030.

The memory card 4000 may communicate with an external host (not shown) via the port region 4040, and the memory controller 4030 may control the nonvolatile memory device 4010. The memory controller 4030 may operate by reading a program from a ROM (not shown) that stores the program. The memory controller 4030, the nonvolatile memory device 4010, and the temperature sensor 4020 of FIG. 18 may be respectively the nonvolatile memory device 100, the temperature sensor 200, and the memory controller 300 of FIG. 1.

It should be understood that example embodiments described herein should be considered in a descriptive sense only and not for purposes of limitation. Descriptions of features or aspects within each device or method according to example embodiments should typically be considered as available for other similar features or aspects in other devices or methods according to example embodiments. While some example embodiments have been particularly shown and described, it will be understood by one of ordinary skill in the art that variations in form and detail may be made therein without departing from the spirit and scope of the claims.

What is claimed is:

1. A nonvolatile memory system comprising:
a nonvolatile memory device including a nonvolatile memory cell array;
a temperature sensor configured to measure a temperature of the nonvolatile memory device; and
a memory controller configured to adjust an execution frequency of a memory management operation performed on the nonvolatile memory device based on a desired temperature range and the measured temperature.

2. The nonvolatile memory system of claim 1, wherein
the memory controller is configured to store information about when the desired temperature range is suitable for performing the memory management operation, and
the memory controller is configured to perform the memory management operation when the measured temperature is in the desired temperature range.

3. The nonvolatile memory system of claim 2, wherein
the memory controller is configured to adjust the temperature of the nonvolatile memory device if the measured temperature of the nonvolatile memory device is outside the desired temperature range

4. The nonvolatile memory system of claim 2, wherein
if the measured temperature of the nonvolatile memory device is outside the desired temperature range, the memory controller is configured to determine whether to perform the memory management operation based on a capacity of an empty space of the nonvolatile memory device where data is to be stored.

5. The nonvolatile memory system of claim 1, wherein the memory controller is configured to increase the execution frequency of the memory management operation if the measured temperature is in the desired temperature range.

6. The nonvolatile memory system of claim 1, wherein
the memory controller is configured to store information about the memory management operation corresponding to each temperature range, and
the memory controller is configured to perform the memory management operation corresponding to a temperature range including the measured temperature.

7. The nonvolatile memory system of claim 1, wherein the nonvolatile memory system is configured to set the desired temperature range based on an operating temperature range of the nonvolatile memory device or operating characteristics of the nonvolatile memory device.

8. The nonvolatile memory system of claim 1, wherein the desired temperature range is set based on a temperature corresponding to a write operation of the nonvolatile memory device.

9. The nonvolatile memory system of claim 1, wherein the memory controller is configured to store a temperature corresponding to a write operation or a read operation of the nonvolatile memory device, and the memory controller is configured to set the desired temperature range based on the stored temperature.

10. The nonvolatile memory system of claim 1, wherein the memory management operation includes at least one of an erase operation for erasing data written to memory cells of the memory cell array, a wear leveling operation for adjusting a number of write operations between the memory cells, a read-refresh operation for adjusting a number of read operations between the memory cells, a garbage collection operation for generating free blocks, and an error check and correction (ECC) operation for correcting an error of written data.

11. The nonvolatile memory system of claim 1, wherein
the memory cell array includes memory cells on a substrate, and
a plurality of the memory cells in a same string are stacked on top of each other in a direction perpendicular to the substrate.

12. A nonvolatile memory system comprising:
a nonvolatile memory device including a memory cell array;
a temperature sensor configured to measure a temperature of the nonvolatile memory device; and
a memory controller configured to perform a memory management operation corresponding to the measured temperature of the nonvolatile memory device.

13. The nonvolatile memory system of claim 12, wherein
the memory controller includes a temperature information storage unit configured to store information about the memory management operation corresponding to each temperature range of the nonvolatile memory device.

14. The nonvolatile memory system of claim 12, wherein the nonvolatile memory system is configured to store temperature information corresponding to an operation of the nonvolatile memory device in a memory cell of the nonvolatile memory device or the memory controller.

15. The nonvolatile memory system of claim 12, wherein the memory controller is configured to perform the memory management operation when the nonvolatile memory device is in an idle state or a sleep state.

16. A nonvolatile memory system comprising:
a nonvolatile memory device including a memory cell array;
a temperature sensor configured to measure a temperature of the nonvolatile memory device; and
a memory controller configured to control at least one of an execution and a delay of a memory management operation performed on the nonvolatile memory device according to a relationship based on the measured temperature, a first temperature threshold, and a second temperature threshold, and
the first temperature threshold is different than second temperature threshold.

17. The nonvolatile memory system of claim 16, wherein
the memory controller is configured to delay the memory management operation if the measured temperature is outside a desired temperature range based on the first temperature threshold and the second temperature threshold, and
the memory controller is configured to perform the memory management operation on the nonvolatile memory device when the measured temperature is inside the desired temperature range.

18. The nonvolatile memory system of claim 17, wherein
the memory controller is configured to adjust the temperature of the nonvolatile memory device if the measured temperature of the nonvolatile memory device is outside the desired temperature range,
the memory controller is configured to re-measure the temperature of the nonvolatile memory device after the temperature of the nonvolatile memory device has been adjusted,
the memory controller is configured to perform the memory management operation on the nonvolatile memory device if the re-measured temperature is inside the desired temperature range.

19. The nonvolatile memory system of claim 16, wherein
if the measured temperature of the nonvolatile memory device is outside a desired temperature range based on the first threshold temperate and the second temperature threshold,
the memory controller is configured to determine whether to perform the memory management operation based on determining an availability of memory resources in the nonvolatile memory device where data is to be stored,
the memory controller is configured to perform the memory management operation on the nonvolatile memory device if the memory controller determines the availability of memory resources is insufficient, and
the memory controller is configured to delay the execution of the memory management operation if the memory controller determines the availability of memory resources is sufficient, and
the memory controller is configured to perform the memory management operation if the measured temperature of the nonvolatile memory device is inside the desired temperature range.

20. The nonvolatile memory system of claim 1, wherein
the memory cell array includes memory cells on a substrate,
a plurality of the memory cells in a same string are stacked on top of each other in a direction perpendicular to the substrate, and
the memory management operation includes at least one of an erase operation for erasing data written to the memory cells of the memory cell array, a wear leveling operation for adjusting a number of write operations between the memory cells, a read-refresh operation for adjusting a number of read operations between the memory cells, a garbage collection operation for generating free blocks, and an error check and correction (ECC) operation for correcting an error of written data.
